(19) United States
(12) Patent Application Publication
(10) Pub. No.: US 2013/0083158 A1
(43) Pub. Date: Apr. 4, 2013

(54) IMAGE PROCESSING DEVICE, IMAGE PROCESSING METHOD AND RECORDING MEDIUM CAPABLE OF GENERATING A WIDE-RANGE IMAGE

(71) Applicant: CASIO COMPUTER CO., LTD., Tokyo (JP)

(72) Inventors: Naotomo MIYAMOTO, Tokyo (JP); Kosuke MATSUMOTO, Tokyo (JP)

(73) Assignee: CASIO COMPUTER CO., LTD., Tokyo (JP)

(21) Appl. No.: 13/630,981

(22) Filed: Sep. 28, 2012

(30) Foreign Application Priority Data
Sep. 29, 2011 (JP) 2011-213890

(51) Int. Cl. H04N 5/262

(52) U.S. Cl. 348/36; 348/E05.051

(57) ABSTRACT

An image acquisition unit 52 acquires images consecutively captured while an image capture range is moved in a predetermined direction. A face detection unit 53 detects same subject images from the images acquired. A facial expression determination unit 55 calculates evaluation values of each of the same subject images detected. A facial expression decision unit 56 decides, as a combination target, a specific subject image from the same subject images, based on the evaluation values calculated. A combination unit 58 generates a wide-range image by combining the subject image decided as the combination target with the images sequentially acquired by the image acquisition unit 52.

This application is based on and claims the benefit of priority from Japanese Patent Application No. 2011-213890, respectively filed on 29 Sep. 2011, the content of which is incorporated herein by reference.

### BACKGROUND OF THE INVENTION

1. Field of the Invention

The present invention relates to an image processing device capable of generating a wide-range image.

2. Related Art

In digital cameras, portable telephones having an image capture function, and the like, the limit of the image capture angle of view depends on the hardware specifications provided by the device main body, such as the focal distance of the lens and size of the imaging elements.

Therefore, conventionally, panoramic photography has been known as one technique for obtaining a wide-angle image exceeding the hardware specifications, e.g., a so-called panoramic image.

In order to realize the aforementioned panoramic photography, a user moves so as to cause the digital camera to rotate horizontally about their body while keeping substantially fixed in the vertical direction, while maintaining a state making a pressing operation on the shutter switch, for example.

Thereupon, the digital camera generates the image data of a panoramic image by executing image capture processing a plurality of times in this period, and transversely (horizontally) combining the image data of the plurality of images each obtained as a result of image capture processing this plurality of times (hereinafter referred to as “captured image”).

Japanese Unexamined Patent Application, Publication No. H11-282100 discloses a method of generating the image data of a panoramic image by detecting a characteristic point in a captured image in each of a plurality of times of image capture processing, and transversely combining the image data of the plurality of captured images so that the characteristic points of two consecutively captured images match.

### SUMMARY OF THE INVENTION

An image processing device according to one aspect of the present invention includes: an image acquisition unit that acquires images consecutively captured, while an image capture range is moved in a predetermined direction; a detection unit that detects same subject images from the images acquired by the image acquisition unit; a calculation unit that calculates evaluation values of the same subject images detected by the detection unit; a decision unit that decides, as a combination target, a specific subject image from the same subject images, based on the evaluation values calculated by the calculation unit; and a generation unit that generates a wide-range image by combining the specific subject image decided as the combination target by the decision unit with the images acquired by the acquisition unit.

In addition, in an image processing method according to one aspect of the present invention, the method for processing images by an image processing device, the method includes the steps of: acquiring images consecutively captured while an image capture range is moved in a predetermined direction; detecting same subject images from the images acquired in the step of acquiring; calculating an evaluation value of each of the subject images detected in the step of detecting; deciding, as a combination target, a specific subject image from a plurality of the subject images, based on the evaluation values respectively calculated in the step of calculating; and generating a wide-range image by combining the subject image decided in the step of deciding with the acquired images.

In addition, a recording medium according to one aspect of the present invention, a computer readable recording medium encoded with a program for enabling a computer to function as: an image acquisition unit that acquires images consecutively captured by an imaging unit moving in a predetermined direction; a detection unit that detects same subject images from the images acquired by the image acquisition unit; a calculation unit that calculates an evaluation value of each subject images detected by the detection unit; a decision unit that decides, as a combination target, a specific subject image from a plurality of the subject images, based on the evaluation values respectively calculated by way of the calculation unit; and a generation unit that generates a panoramic (wide-range) image by combining the subject image decided by the decision unit with the acquired images.

### BRIEF DESCRIPTION OF THE DRAWINGS

FIG. 1 is a block diagram showing a hardware configuration of a digital camera as one embodiment of an image capture device according to the present invention;

FIG. 2 is a functional block diagram showing a functional configuration for the digital camera of FIG. 1 to execute imaging processing;

FIG. 3 presents views illustrating image capture operations in cases of normal photography mode and panoramic photography mode being respectively selected as the operation mode of the digital camera of FIG. 2;

FIG. 4 is a view showing an example of a panoramic image generated according to the panoramic photography mode shown in FIG. 3;

FIG. 5 is a view showing an example of image data used in the combination of a panoramic image and image data of a panoramic image generated from this image data;

FIG. 6 is a flowchart showing an example of the flow of image capture processing executed by the digital camera of FIG. 2;

FIG. 7 is a flowchart showing the detailed flow of panoramic image-capture processing in the image capture processing of FIG. 6;

FIG. 8 is a flowchart showing the detailed flow of facial-expression determination processing in the panoramic image-capture processing of FIG. 7; and

FIG. 9 is a flowchart showing the detailed flow of image combination processing in the panoramic image-capture processing of FIG. 7.

### DETAILED DESCRIPTION OF THE INVENTION

Hereinafter, embodiments relating to the present invention will be explained while referencing the drawings.

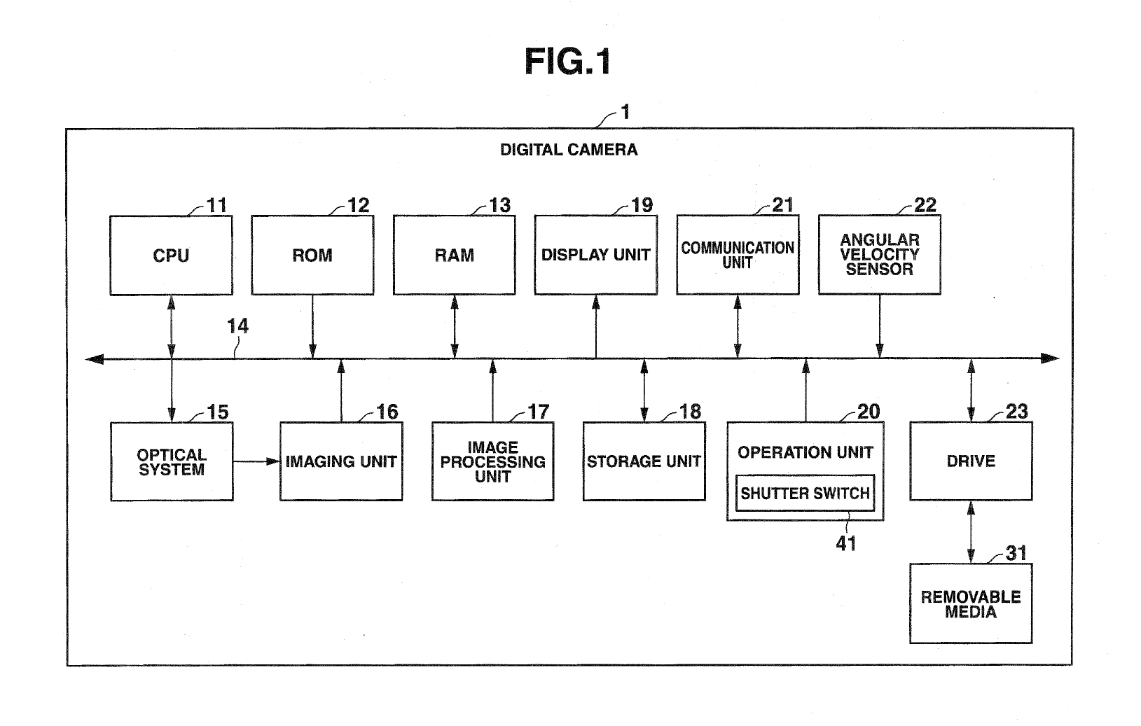

FIG. 1 is a block diagram showing the hardware configuration of a digital camera 1 as one embodiment of an image processing device according to the present invention.

The digital camera 1 includes a CPU (Central Processing Unit) 11, ROM (Read Only Memory) 12, RAM (Random Access Memory) 13, a bus 14, an optical system 15, an imaging unit 16, an image processing unit 17, a storage unit 18, a display unit 19, an operation unit 20, a communication unit 21, an angular velocity sensor 22, and a drive 23.

The CPU 11 executes various processing in accordance with programs stored in the ROM 12, or programs loaded from the storage unit 18 into the RAM 13. In addition to programs for the CPU 11 to execute various processing, the ROM 12 stores the necessary data and the like upon the CPU 11 executing various processing, as appropriate.

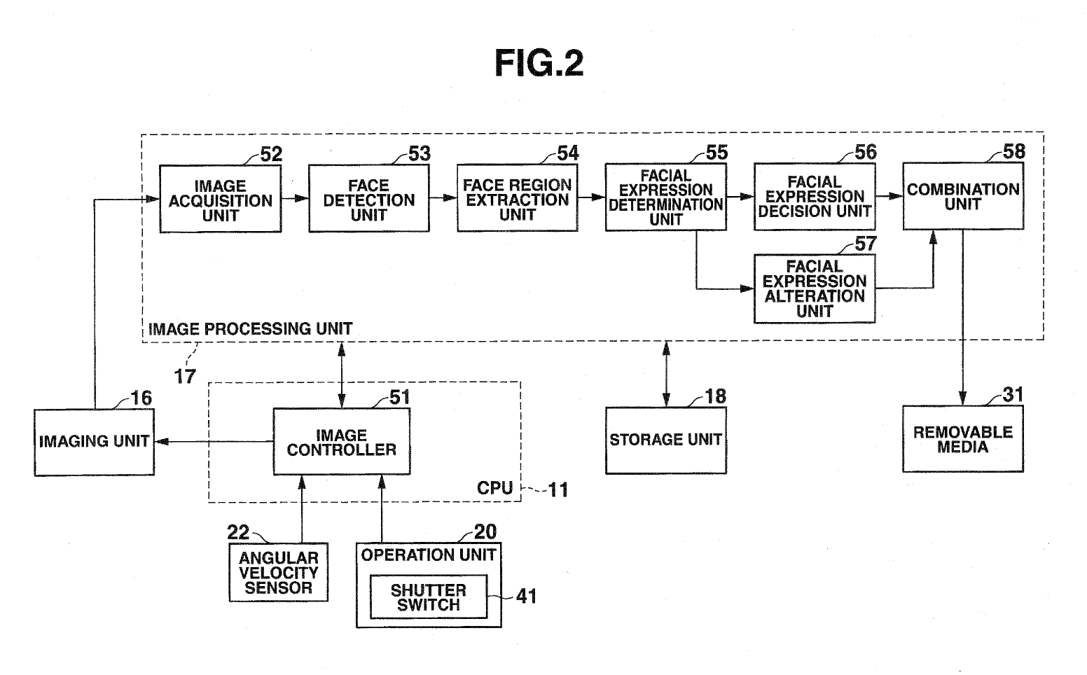

For example, programs for realizing the respective functions of an image controller 51 to a combination unit 58 in FIG. 2 described later are stored in the ROM 12 and storage unit 18 in the present embodiment. Therefore, the CPU 11 can realize the respective functions of the image controller 51 to the combination unit 58 in FIG. 2 described later, by executing the processing in accordance with these programs, and cooperating as appropriate with the image processing unit 17 described later.

The CPU 11, ROM 12 and RAM 13 are connected to each other via the bus 14. The optical system 15, the imaging unit 16, the image processing unit 17, the storage unit 18, the display unit 19, the operation unit 20, the communication unit 21, the angular velocity sensor 22 and the drive 23 are also connected to this bus 14.

The optical system 15 is configured by a lens that condenses light in order to capture an image of a subject, e.g., a focus lens, zoom lens, etc. The focus lens is a lens that causes a subject image to form on the light receiving surface of imaging elements of the imaging unit 16. The zoom lens is a lens that causes the focal length to freely change in a certain range. Peripheral devices that adjust the focus, exposure, etc. can also be provided to the optical system 15 as necessary.

The imaging unit 16 is configured from photoelectric conversion elements, AFE (Analog Front End), etc. The photoelectric conversion elements are configured from CCD (Charge Coupled Device) or CMOS (Complementary Metal Oxide Semiconductor)-type photoelectric conversion elements. Every predetermined time period, the photoelectric conversion elements photoelectrically convert (capture) an optical signal of an incident and accumulated subject image during this period, and sequentially supply the analog electric signals obtained as a result thereof to the AFE.

The AFE conducts various signal processing such as A/D (Analog/Digital) conversion processing on these analog electric signals, and outputs the digital signals obtained as a result thereof as output signals of the imaging unit 16.

It should be noted that the output signal of the imaging unit 16 will be referred to as “image data of captured image” hereinafter. Therefore, the image data of the captured image is outputted from the imaging unit 16, and supplied as appropriate to the image processing unit 17, etc.

The image processing unit 17 is configured from a DSP (Digital Signal Processor), VRAM (Video Random Access Memory), etc.

In addition to image processing such as noise reduction, white balance and image stabilization on the image data of a captured image input from the imaging unit 16, the image processing unit 17 conducts various image processing required in the realization of the respective functions of an image acquisition unit 52 to the combination unit 58 described later, in cooperation with the CPU 11.

Herein, unless otherwise noted, “image data” hereinafter refers to image data of a captured image outputted from the imaging unit 16 every predetermined time period, or data in which this image data has been processed or the like. In other words, in the present embodiment, this image data is adopted as a unit of processing.

The storage unit 18 is configured by DRAM (Dynamic Random Access Memory), etc., and temporarily stores image data outputted from the image processing unit 17, image data of a panoramic intermediate image described later, and the like. In addition, the storage unit 18 also stores various data and the like required in various image processing.

The display unit 19 is configured as a flat display panel consisting of an LCD (Liquid Crystal Device) and LCD driver, for example. The display unit 19 displays images representative of the image data supplied from the storage unit 18 or the like, e.g., a live-view image described later, in a unit of image data.

Although not illustrated, the operation unit 20 has a plurality of switches in addition to a shutter switch 41, such as a power switch, photography mode switch and playback switch. When a predetermined switch among this plurality of switches is subjected to a pressing operation, the operation unit 20 supplies a command assigned for the predetermined switch to the CPU 11.

The communication unit 21 controls communication with other devices (not illustrated) via a network including the Internet.

The angular velocity sensor 22 consists of a gyro and the like, detects the displacement in the horizontal direction of the digital camera 1 accompanying rotation about the body of the user during panoramic image capturing, and supplies a digital signal indicating the detection results (hereinafter referred to simply as “amount of angular displacement”) to the CPU 11. It should be noted that the angular velocity sensor 22 is established to also exhibit the function of a direction sensor as necessary.

A removable media 31 made from a magnetic disk, optical disk, magneto-optical disk, semiconductor memory, or the like is installed in the drive 23 as appropriate. Then, programs read from the removable media 31 are installed in the storage unit 18 as necessary. In addition, similarly to the storage unit 18, the removable media 31 can also store various data such as the image data stored in the storage unit 18.

FIG. 2 is a functional block diagram showing a functional configuration for executing a sequence of processing (hereinafter referred to as “image capture processing”), in the processing executed by the digital camera 1 of FIG. 1, from capturing an image of a subject until recording image data of the captured image obtained as a result thereof in the removable media 31.

As shown in FIG. 2, in a case of image capture processing being executed, the image controller 51 functions in the CPU 11, and the image acquisition unit 52, a face detection unit 53, a face region extraction unit 54, a facial expression determination unit 55, a facial expression decision unit 56, a facial expression alteration unit 57, and the combination unit 58 function in the image processing unit 17. It should be noted that the functions of the image controller 51 do not particularly need to be built into the CPU 11 as in the present embodiment, and the functions can also be assigned to the image processing unit 17. Conversely, the respective functions of the image acquisition unit 52 to the combination unit 58 do not particularly need to be built into the image processing unit 17 as in the present embodiment, and at least a part of these functions can also be assigned to the CPU 11.

The image controller 51 controls the overall execution of image capture processing. For example, the image controller 51 selectively switches between normal photography mode and a panoramic photography mode as the operation modes of the digital camera 1, and executes processing in the accordance with the switched operation mode. When in the panoramic photography mode, the image acquisition unit 52 to the combination unit 58 operate under the control of the image controller 51.

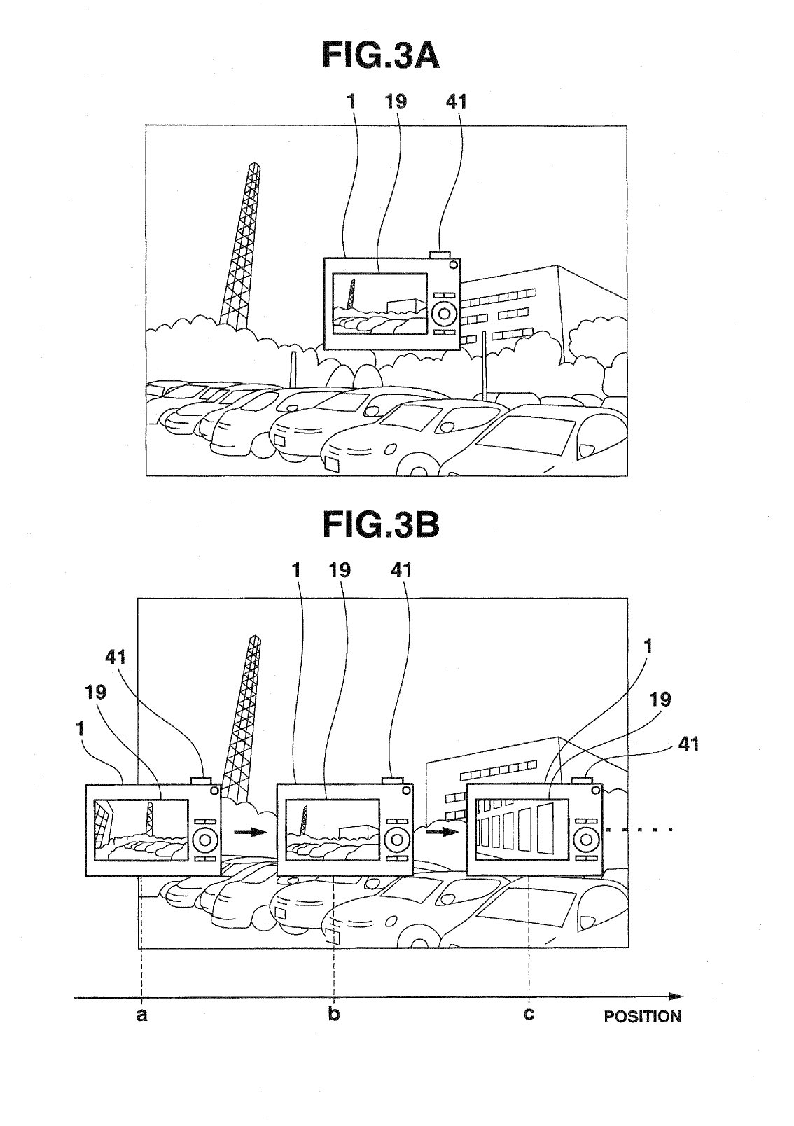

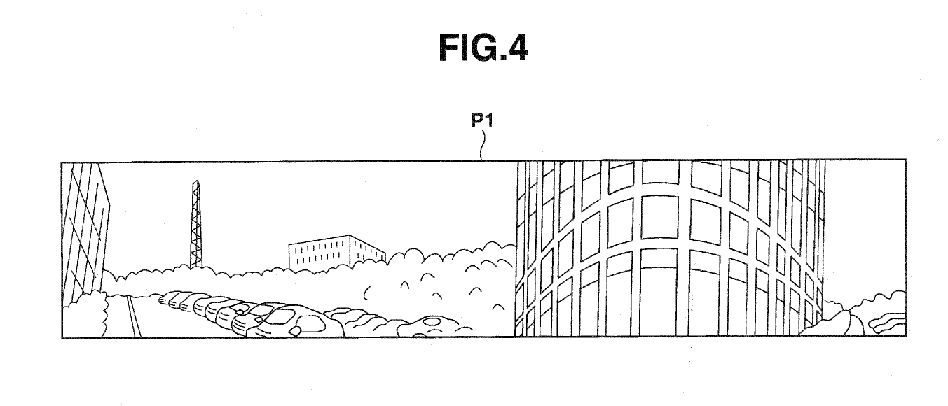

Herein, in order to facilitate understanding of the image controller 51 to the combination unit 58, prior to explanation of these functional configurations, the panoramic photography mode will be explained in detail while referencing FIGS. 3 and 4 as appropriate.

FIG. 3 presents views illustrating image capture operations in cases of normal photography mode and panoramic photography mode being respectively selected as the operation mode of the digital camera 1 of FIG. 1. In detail, FIG. 3A is a view illustrating the image capture operation in the normal photography mode. FIG. 3B is a view illustrating the image capture operation in the panoramic photography mode.

In each of FIGS. 3A and 3B, the picture that is inside of the digital camera 1 indicates the appearance of the real world including the subject of the digital camera 1. In addition, the vertical dotted lines shown in FIG. 3B indicate the respective positions a, b and c in a movement direction of the digital camera 1. The movement direction of the digital camera 1 refers to the direction in which the optical axis of the digital camera 1 moves when the user causes the image capture direction (angle) of the digital camera 1 to change about their body. The displacement in the movement direction of the digital camera 1 is detected as an amount of angular displacement by the angular velocity sensor 22.

The normal photography mode refers to an operation mode when capturing an image of a size (resolution) corresponding to the angle of view of the digital camera 1.

In the normal photography mode, the user presses the shutter switch 41 of the operation unit 20 to the lower limit while making the digital camera 1 stationary, as shown in FIG. 3A. It should be noted that the operation to press the shutter switch 41 to the lower limit will hereinafter be referred to as “full press operation” or simply “fully press”.

The image controller 51 controls execution of a sequence of processing immediately after a full press operation has been made until causing image data outputted from the image processing unit 17 to be recorded in the removable media 31 as a recording target.

Hereinafter, the sequence of processing executed according to the control of the image controller 51 in the normal photography mode is referred to as “normal image capture processing”.

On the other hand, the panoramic photography mode refers to the operation mode when capturing a panoramic image.

As shown in FIG. 3B, in the panoramic photography mode, the user causes the digital camera 1 to move in the black arrow direction in the same figure, while maintaining the full press operation of the shutter switch 41.

During the period in which the full press operation is maintained, the image controller 51 controls the image acquisition unit 52 to the combination unit 58 so as to repeat, every time the amount of angular displacement from the angular velocity sensor 22 reaches a fixed value, acquiring image data outputted from the imaging unit 16 and temporarily storing in the storage unit 18 immediately thereafter.

Subsequently, the image controller 51 controls the image acquisition unit 52 to the combination unit 58 so as to generate the image data of a panoramic image by sequentially combining consecutive image data stored in the storage unit 18 in the horizontal direction. Herein, consecutive image data refers to the image data of a captured image obtained by image capturing a K^{th} time (K being a positive integer of at least 1) during panoramic image capture, and the image data of a captured image obtained by image capture a K+1^{th} time in the same panoramic image capture. It should be noted that combination of image data is not limited to the combination of two consecutive image data sets, and it may be configured so as to be performed every time acquiring any plurality of image data sets of at least 2 serving as combination targets, or it may be configured so as to be performed after acquiring all of the image data serving as combination targets.

Subsequently, when the end of panoramic image capture is instructed by the user making an operation to release the full press operation, i.e. an operation to distance a finger or the like from the shutter switch 41 (hereinafter such an operation is referred to as “release operation”), the image controller 51 controls the combination unit 58, etc. so as to cause the image data of a panoramic image to be recorded in the removable media 31 as a recording target.

In this way, the control unit 51 controls the image acquisition unit 52 to the combination unit 58 in the panoramic photography mode, and controls a sequence of processing from generating the image data of a panoramic image until causing this to be recorded in the removable media 31 as a recording target.

Hereinafter, the sequence of processing executed according to the control of the image controller 51 in the panoramic photography mode in this way is referred to as “panoramic image-capture processing”.

FIG. 4 shows the image data of a panoramic image generated by the image acquisition unit 52 to the combination unit 58 in the panoramic photography mode shown in FIG. 3.

In other words, in the panoramic photography mode, when an image capture operation such as that shown in FIG. 3B is performed, the image data of a panoramic image P1 such as that shown in FIG. 4 is generated and is recorded in the removable media 31 by the image acquisition unit 52 to the combination unit 58, under the control of the image controller 51.

Herein, in a case of generating the image data of a panoramic image containing a subject such as a person in the panoramic photography mode, the subject may differ in each of the plurality of image data prior to combination, and in such a case, it is preferable to generate image data of a panoramic image containing the subject at their most attractive. More specifically, in each of the plurality of image data prior to combination of a panoramic image, the person may have their eyes shut in certain image data, and have their eyes open in other image data, and in such a case, it is preferable to generate image data of a panoramic image containing a person with their eyes open.

As a result, with the digital camera 1 according to the present embodiment, the image acquisition unit 52 to the combination unit 58 execute the following processing under the control of the image controller 51.

The image acquisition unit 52 receives an acquisition command issued from the image controller 51 every time the digital camera 1 moves by a predetermined amount (every time the amount of angular displacement reaches a fixed value), and sequentially acquires image data from the image processing unit 17.

The face detection unit 53 analyzes the image data acquired by the image acquisition unit 52, and detects information (at least includes the position and size of a face portion) of a face of a person included in this image data. It should be noted that detection of a face by the face detection unit 53 can be performed by any previously known method.

The face region extraction unit 54 extracts a face region from the image data in which a face was detected by the face detection unit 53. It should be noted that any favorable region can be set in the combination processing as the face region to be extracted, e.g., it may define the region of a face portion including the eyes, nose and mouth, it may define a region including a face portion and a head portion, and may define a region including the entire person included in the image data.

The facial expression determination unit 55 performs facial expression determination on the face detected by the face detection unit 53. Facial expression determination is processing for determining a favorable facial expression (smiling face) of a person as the captured image, for example, and is executed by establishing scores in advance for the size of the eyes, shape of the mouth, etc., evaluating the face detected by the face detection unit 53 with these scores, and calculating the evaluation value of the face that is the determination target.

The facial expression decision unit 56 decides a face having an evaluation value calculated by the facial expression determination unit 55 of equal to or more than a predetermined value (at least a predetermined value), and stores the image data of the face region including the decided face in memory (storage unit 18 in the present embodiment). It should be noted that the facial expression decision unit 56 may be configured so as to decide the face having the highest calculated evaluation value as the face of the combination target. In addition, the evaluation value equal to or more than a predetermined value (at least a predetermined value) can be arbitrarily set, e.g., an evaluation value that is a smiling face can be set.

The facial expression alteration unit 57 alters the image data of the face region containing the face having an evaluation value calculated by the facial expression determination unit 55 less than the predetermined value to the image data of a face region containing the face decided by the facial expression decision unit 56 as the combination target.

The combination unit 58 combines consecutive image data among the image data acquired by the image acquisition unit 52 to generate the image data of a panoramic image. More specifically, among the altered image data of the face region by the facial expression alteration unit 57, which is image data acquired by the image acquisition unit 52, the combination unit 58 combines consecutive image data to generate the image data of a panoramic image. In other words, among the faces of the person included in the plurality of image data sets acquired by the image acquisition unit 52, the combination unit 58 executes processing equivalent to generating image data of a panoramic image using the face decided by the facial expression decision unit 56.

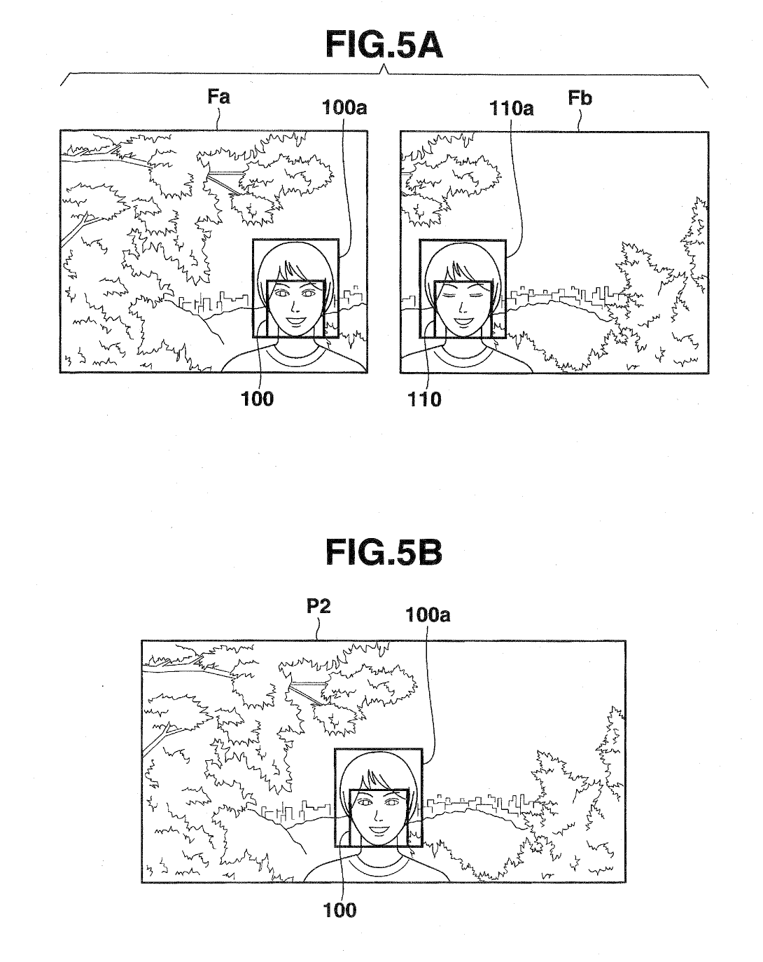

The above such image data of the panoramic image generated by the image acquisition unit 52 to the combination unit 58 will be explained while referencing FIG. 5. FIG. 5A shows the image data acquired by the image acquisition unit 52 used in the combination of a panoramic image. FIG. 5B shows the image data of a panoramic image generated from the image data of FIG. 5A.

Referencing FIG. 5A, when the image data of a captured image Fa is acquired by the image acquisition unit 52, the face detection unit 53 detects a face 100 of a subject(a person“A”) from the captured image Fa. Next, the face region extraction unit 54 extracts a face region 100a from the captured image Fa in which the face 100 was detected. It should be noted that any region can be set for the face region 100a, e.g., it may define a region of only the face 100, it may define a region combining the face 100 and the head (hair) as shown in FIG. 5A, and it may define an entire region of the person included in the captured image Fa.

Next, the facial expression determination unit 55 calculates an evaluation value for the face 100 in the captured image Fa from the size of the eyes, shape of the mouth, etc. In FIG. 5A, the face 100 is a smiling face and the eyes are opened wide; therefore, the facial expression determination unit 55 specifies an evaluation value equal to or more than a predetermined value (at least a predetermined value). As a result, the facial expression decision unit 56 decides the face 100 as the face to be used in the panoramic image, and stores image data of the portion of the face region 100a of the face 100 in the storage unit 18.

Similarly, when the image data of a captured image Fb is consecutively acquired by the image acquisition unit 52 after the image data of the captured image Fa, the face detection unit 53 detects a face 110 of the subject(the same person“A”) from the captured image Fb, and the face region extraction unit 54 extracts a face region 110a from the image data of the captured image Fb in which the face 110 was detected.

Next, the facial expression determination unit 55 calculates an evaluation value for the face 110 in the captured image Fb; however, in the captured image Fb of FIG. 5A, the face 110 has the eyes closed; therefore, the facial expression determination unit 55 calculates an evaluation value less than the predetermined value. As a result, the facial expression alteration unit 57 alters the image data of the portion of the face region 110a of the face 110 to the image data of the portion of the face region 100a of the face 100 stored in the storage unit 18.

Thereafter, the combination unit 58 generates the image data of a panoramic image P2 shown in FIG. 5B, by sequentially combining the image data of each of the plurality of captured images including the captured image Fa and the captured image Fb. At this time, since the panoramic image P2 is generated using the face region 100a of the face 100 decided by the facial expression decision unit 56, it is possible to obtain the panoramic image P2 including the a more attractive subject as a picture, as shown in FIG. 5B.

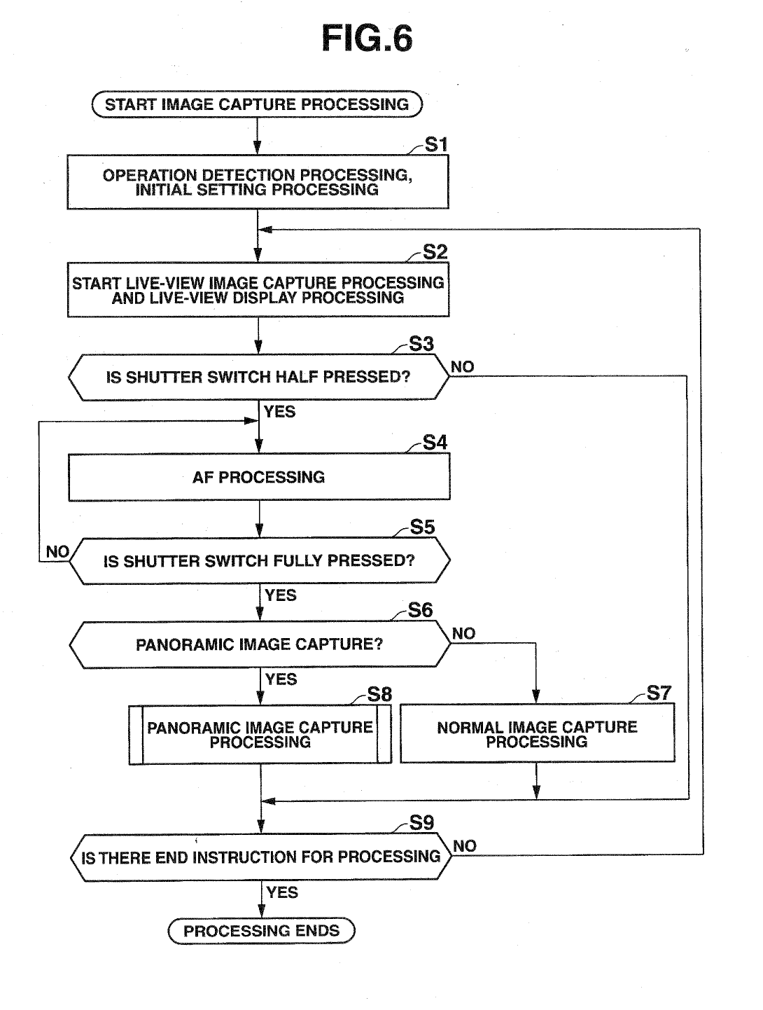

The functional configuration of the digital camera 1 to which the present invention is applied has been explained in the foregoing while referencing FIGS. 2 to 5. Next, image capture processing executed by the digital camera 1 having such a functional configuration will be explained while referencing FIG. 6.

FIG. 6 is a flowchart showing an example of the flow of image capture processing. In the present embodiment, image capture processing starts when a power source (not illustrated) of the digital camera 1 is turned ON, and a predetermined condition is satisfied.

In Step S1, the image controller 51 of FIG. 2 executes operation detection processing and initial setting processing.

The operation detection processing refers to processing to detect the state of each switch in the operation unit 20. The image controller 51 can detect if the normal photography mode is set as the operation mode, or if the panoramic photography mode is set, by executing operation detection processing.

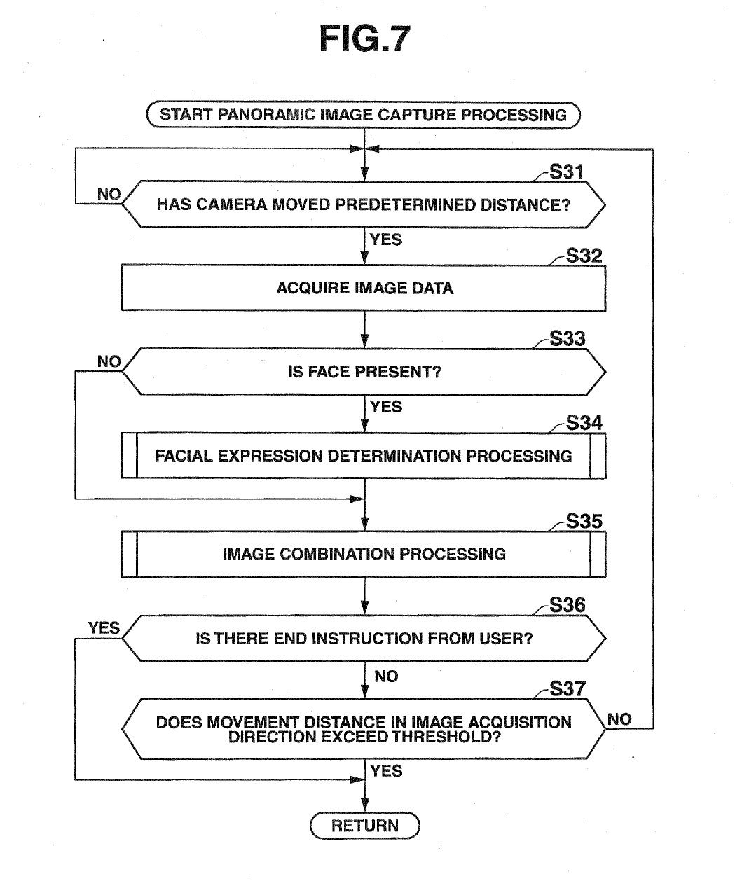

In addition, as one type of initial setting processing of the present embodiment, processing is employed to set a fixed value of the amount of angular displacement and an angular displacement threshold (e.g., 360°), which is the maximum limit for the amount of angular displacement. More specifically, the fixed value for the amount of angular displacement and the angular displacement threshold (e.g., 360°) that is the maximum limit for the amount of angular displacement, are stored in advanced in the ROM 12 of FIG. 1, and are set by reading from the ROM 12 and writing into the RAM 13. It should be noted that the fixed value for the amount of angular displacement is used in the determination processing of Step S31 in FIG. 7 described later. On the other hand, the angular displacement threshold (e.g., 360°) that is the maximum limit for the amount of angular displacement is used in the determination processing of Step S37 in FIG. 7.

In Step S2, the image controller 51 starts live-view image capture processing and live-view display processing.

In other words, the image controller 51 controls the imaging unit 16, etc. to cause the image capture operation to continue by the imaging unit 16. Then, while the image capture operation is being continued by the imaging unit 16, the image controller 51 causes the image data sequentially outputted from the imaging unit 16 to be temporarily stored in memory (in the present embodiment, the storage unit 18). Such a sequence of control processing by the image controller 51 is herein referred to as “live-view image capture processing”.

In addition, the image controller 51 sequentially reads the respective image data temporarily recorded in the memory (in the present embodiment, the storage unit 18) during live-view image capture, and causes the respectively corresponding images to be sequentially displayed on the display unit 19. Such a sequence of control processing by the image controller 51 is referred to herein as “live-view display processing”. It should be noted that the image being displayed on the display unit 19 according to the live-view display processing is referred to as “live-view image”.

In Step S3, the image controller 51 determines whether or not the shutter switch 41 has been half pressed. Herein, half press refers to an operation depressing the shutter switch 41 of the operation unit 20 midway (a predetermined position short of the lower limit), and hereinafter is also called “half press operation” as appropriate.

In a case of the shutter switch 41 not being half pressed, it is determined as NO in Step S3, and the processing advances to Step S9.

In Step S9, the image controller 51 determines whether or not an end instruction for processing has been made. Although the end instruction for processing is not particularly limited, in the present embodiment, the notification of the event of the power source (not illustrated) of the digital camera 1 having entered an OFF state is adopted thereas.

Therefore, in the present embodiment, when the power source enters the OFF state and such an event is notified to the image controller 51, it is determined as YES in Step S9, and the overall image capture processing comes to an end.

In contrast, in the case of the power source being in an ON state, since notification of the event of the power source having entered the OFF state is not made, it is determined as NO in Step S9, the processing is returned to Step S2, and this and following processing is repeated. In other words, in the present embodiment, so long as the power source maintains the ON state, in a period until the shutter switch 41 is half pressed, the loop processing of Step S3: NO and Step S9: NO is repeatedly executed, whereby the image capture processing enters a standby state.

On the other hand, during the live-view display processing, if the shutter switch 41 is half pressed, it is determined as YES in Step S3, and the processing advances to Step S4.

In Step S4, the image controller 51 executes so-called AF (Auto Focus) processing by controlling the imaging unit 16.

In Step S5, the image controller 51 determines whether or not the shutter switch 41 is fully pressed.

In the case of the shutter switch 41 not being fully pressed, it is determined as NO in Step S5. In this case, the processing is returned to Step S4, and this and following processing is repeated. In other words, in the present embodiment, in a period until the shutter switch 41 is fully pressed, the loop processing of Step S4 and Step S5: NO is repeatedly executed, and the AF processing is executed each time.

Thereafter, when the shutter switch 41 is fully pressed, it is determined as YES in Step S5, and the processing advances to Step S6. In Step S6, the image controller 51 determines whether or not the photography mode presently set is the panoramic photography mode.

In the case of not being the panoramic photography mode, i.e. in a case of the normal photography mode presently being set, it is determined as NO in Step S6, and the processing advances to Step S7. In Step S7, the image controller 51 executes the aforementioned normal image capture processing. In other words, one image data set outputted from the image processing unit 17 immediately after a full press operation was made is recorded in the removable media 31 as the recording target. The normal image capture processing of Step S7 thereby ends, and the processing advances to Step S9. It should be noted that, since the processing of Step S9 and after have been described in the foregoing, an explanation thereof will be omitted herein.

In contrast, in the case of the panoramic photography mode being presently set, it is determined as YES in Step S6, and the processing advances to Step S8.

In Step S8, the image controller 51 executes the aforementioned panoramic image-capture processing.

Although the details of the panoramic image-capture processing will be described later while referencing FIG. 7, the image controller 51 generates the image data of a panoramic image and records in the removable media 31 as a recording target. The panoramic image-capture processing of Step S8 thereby ends, and the processing advances to Step S9. It should be noted that, since the processing of Step S9 and after has been described in the foregoing, an explanation thereof will be omitted herein.

The flow of image capture processing has been explained in the foregoing while referencing FIG. 6. Next, the detailed flow of panoramic image-capture processing of Step S8 in the image capture processing of FIG. 6 will be explained while referencing FIG. 7.

FIG. 7 is a flowchart illustrating the detailed flow of panoramic image-capture processing. As described in the foregoing, when the shutter switch 41 is fully pressed in the state of the panoramic photography mode, it is determined as YES in Steps S5 and S6 in FIG. 6, the processing advances to Step S8, and the following processing is executed as the panoramic image-capture processing.

In Step S31, the image controller 51 determines whether or not the digital camera 1 has moved by a predetermined distance. In other words, the image controller 51 determines whether or not the amount of angular displacement supplied from the angular velocity sensor 22 has reached a fixed value. The digital camera 1 moving a predetermined distance and the amount of angular displacement changing to exceed a fixed value mean that the image capture range of the digital camera is moving.

In a case of the digital camera 1 not having moved by a predetermined distance, it is determined as NO in Step S31. In this case, the processing is returned to Step S31. In other words, the panoramic image-capture processing enters a standby state until the digital camera 1 moves by a predetermined distance.

In contrast, in a case of the digital camera 1 having moved by a predetermined distance, it is determined as YES in Step S31, and the processing advances to Step S32.

In Step S32, the image acquisition unit 52 acquires image data (combination target) outputted from the imaging unit 16, under the control of the image controller 51. In other words, every time the amount of angular displacement supplied from the angular velocity sensor 22 reaches a fixed value, the image acquisition unit 52 acquires image data outputted from the imaging unit 16 immediately thereafter.

In Step S33, under the control of the image controller 51, the face detection unit 53 analyzes the image data acquired by the image acquisition unit 52, and determines whether or not the face of a person (subject image) is present in the image data.

In the case of the face of a person not being present in the image data, it is determined as NO in Step S33, and in this case, the processing advances to Step S35.

On the other hand, in a case of the face of a person being present in the image data, it is determined as YES in Step S33, and in this case, the processing advances to Step S34.

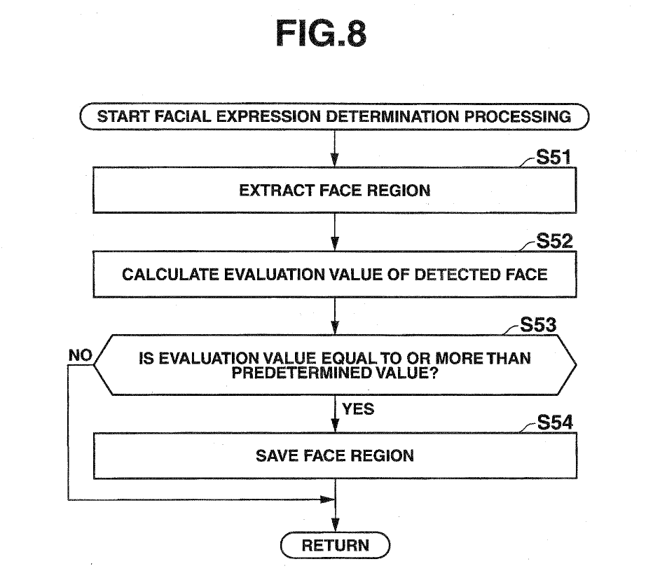

In Step S34, the image controller 51 performs facial expression determination processing. Although the details of facial expression determination processing will be described later while referencing FIG. 8, the image controller 51 controls the facial expression determination unit 55 so as to determine the facial expression of a face included in the image data. The facial expression determination processing of Step S34 thereby ends, and the processing advances to Step S35.

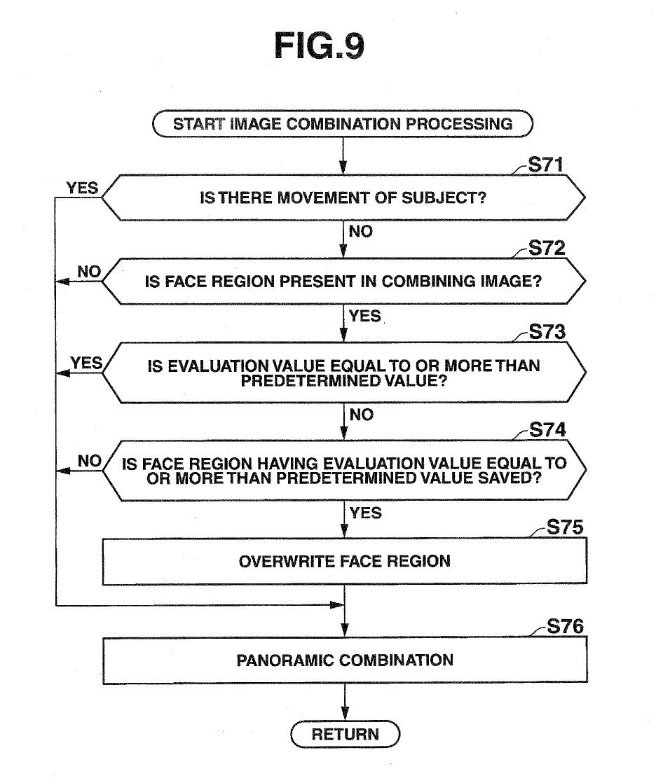

In Step S35, the image controller 51 performs image combination processing. Although the details of the image combination processing will be described later while referencing FIG. 9, the image controller 51 controls the combination unit 58 so as to sequentially combine consecutive image data to generate the image data of a panoramic image. The image combination processing of Step S35 thereby ends, and the processing advances to Step S36.

In Step S36, the image controller 51 determines whether or not there is an end instruction from the user. Although the end instruction from the user can be arbitrarily set, for example, the release of fully pressing the shutter switch 41 by the user can be defined as the end instruction from the user.

In the case of there being an end instruction from the user, it is determined as YES in Step S36, and the panoramic image-capture processing ends.

On the other hand, in the case of there not being an end instruction from the user, it is determined as NO in Step S36, and in this case, the processing advances to Step S37.

In Step S37, the image controller 51 determines whether or not the movement distance in an image acquisition direction exceeds a threshold. In other words, the image controller 51 determines whether or not a cumulative value for the amount of angular displacement supplied from the angular velocity sensor 22 has reached an angular displacement threshold (e.g., 360°), which is a maximum limit.

In a case of the movement distance in the image capture direction having exceeded the threshold, it is determined as YES in Step S37, and the panoramic image-capture processing ends.

On the other hand, in the case of the movement distance in the image acquisition direction not having exceeded the threshold, it is determined as NO in Step S37, and in this case, the processing is returned to Step S31. In other words, in a case of the movement distance in the image acquisition direction not exceeding the threshold without there being an end instruction from the user, the panoramic image-capture processing continues, and the processing of the acquisition of new image data and the combination of this image data is repeated.

The flow of panoramic image-capture processing has been explained in the foregoing while referencing FIG. 7. Next, the detailed flow of the facial expression determination processing of Step S34 in the panoramic image-capture processing of FIG. 7 will be explained while referencing FIG. 8. FIG. 8 is a flowchart illustrating the detailed flow of facial expression determination processing.

In Step S51, the face region extraction unit 54 extracts a face region from the image data including the face of a person, under the control of the image controller 51. It should be noted, as described in the foregoing, the face region may be defined as a region of only a face portion including the eyes, nose and mouth, it may be defined as a region including a face portion and a head portion, and may be defined as a region including the entire person.

In Step S52, when extracting the face region, the facial expression determination unit 55 calculates an evaluation value of the face detected by the face detection unit 53, under the control of the image controller 51. In other words, the facial expression determination unit 55 calculates the evaluation value of the face of the determination target, based on the size of the eyes of the face, shape of the mouth, etc. included in the image data.

Subsequently, in Step S53, the facial expression determination unit 55 determines whether or not the calculated evaluation value is at least a predetermined value, under the control of the image controller 51.

In the case of the calculated evaluation value not being at least the predetermined value, it is determined as NO in Step S53, and the facial expression determination processing ends.

On the other hand, in the case of the calculated evaluation value being at least the predetermined value, it is determined as YES in Step S53, and in this case, the processing advances to Step S54.

In Step S54, the facial expression decision unit 56 saves the image data of the portion of the face region of the face determined as having an evaluation value of at least the predetermined value in the storage unit 18, and ends the facial expression determination processing, under the control of the image controller 51.

The flow of facial expression determination processing has been explained in the foregoing while referencing FIG. 8.

Next, the detailed flow of image combination processing of Step S35 in the panoramic image-capture processing of FIG. 7 will be explained while referencing FIG. 9. FIG. 9 is a flowchart illustrating the detailed flow of image combination processing.

In Step S71, the image controller 51 determines whether or not there is movement of the subject in the consecutive image data serving as the combination target. In this regard, in the present embodiment, it is configured so that image data of the portion of the face region having an evaluation value less than the predetermined value is overwritten by the image data of the portion of the face region having an evaluation value of at least the predetermined value (Step S75 described later). As a result, movement of the subject in Step S71 refers to movement not suited to the overwriting of image data of the face region, e.g., refers to movement whereby the shape of the face region changes, movement whereby the position of the face region in the angle of view changes (taking account of the amount of angular displacement), and the like. On the other hand, movement of the subject within the face region, e.g., a change in the facial expression such as the eyes closing, is not included as movement of the subject in Step S71.

In a case of there being movement of the subject, it is determined as YES in Step S71, and in this case, the processing advances to Step S76.

On the other hand, in a case of there not being movement of the subject, it is determined as NO in Step S72, and in this case, the processing advances to Step S72.

In Step S72, the image controller 51 determines whether or not a face region exists in the combining image data. It should be noted that, in the present embodiment, combining image data may be defined as image data set acquired later among the consecutive image data, and may be defined as both of the consecutive image data sets.

In a case of a face region not existing in the combining image data, it is determined at NO in Step S72, and in this case, the processing advances to Step S76.

In a case of a face region existing in the combining image data, it is determined as YES in Step S72, and in this case, the processing advances to Step S73.

In Step S73, the facial expression determination unit 55 determines whether or not the evaluation value of the face region of the combining image data is at least the predetermined value, under the control of the image controller 51.

In a case of the evaluation value of the face region of the combining image data being at least the predetermined value, it is determined as YES in Step S73, and in this case, the processing advances to Step S76.

On the other hand, in a case of the evaluation value of the face region of the combining image data not being at least the predetermined value, it is determined as NO in Step S73, and in this case, the processing advances to Step S74.

In Step S74, the facial expression alteration unit 57 determines whether or not the image data of the portion of the face region having an evaluation value of at least the predetermined value is saved in the storage unit 18, under the control of the image controller 51.

In a case of the image data of the portion of the face region having an evaluation value of at least the predetermined value not being saved in the storage unit 18, it is determined as NO in Step S74, and in this case, the processing advances to Step S76.

On the other hand, in a case of the image data of the portion of the face region having an evaluation value of at least the predetermined value being saved in the storage unit 18, it is determined as YES in Step S74, and in this case, the processing advances to Step S75.

In Step S75, the facial expression alteration unit 57 overwrites the image data of the portion of the face region determined as having an evaluation value less than the predetermined value in Step S73 by the image data of the portion of the face region having an evaluation value of at least the predetermined value saved in the storage unit 18.

Subsequently, in Step S76, the combination unit 58 combines consecutive image data sets to generate the image data of a panoramic image, and then ends the image combination processing, under the controller of the image controller 51.

According to the above such digital camera 1 of the present embodiment, when the face detection unit 53 detects the face of a person included in the image data, the facial expression determination unit 55 performs facial expression determination on this face. Then, the facial expression decision unit 56 decides, as the face of the person of the combination target, a face suitable as a captured image in accordance with the result of the facial expression determination by the facial expression determination unit 55, and the combination unit 58 performs panoramic combination so as to include the decided face of the person.

Even in a case of the facial expression of the person that is the subject during image capture of a panoramic image, e.g., in a case of the eyes closing during image capture of a panoramic image, it is possible to generate the image data of a panoramic image using the image data captured at a timing with the eyes opened, and not at the timing with the eyes closed, and thus a panoramic image containing the person with a suitable facial expression can be obtained.

In addition, with the digital camera 1, the face region extraction unit 54 extracts a face region containing the face of a person from the image data of a combination target, and the facial expression decision unit 56 saves the image data of the portion of the face region containing a face suited as a captured image in the storage unit 18. Then, in a case of the face included in the combining image data not being preferable as a captured image, the facial expression alteration unit 57 overwrites this face region with the image data of the portion of the face region saved in the storage unit 18, and then performs panoramic combination.

It is thereby possible to prevent a face not preferable and face suitable as a captured image from being combined, and natural panoramic combination can be performed.

In addition, the way of panoramic combination in a case of a plurality of persons being present in the image capture range that is the target of the panoramic image-capture processing will be described hereinafter as a modified embodiment.

### Modified Embodiment

In a case of a plurality of persons (for example, persons “A”, “B”, “C”) being present in the image capture range that is the target of panoramic image-capture processing, using the information of the face of each of the persons (each of the persons “A”, “B”, “C”) initially detected by the face detection unit 53, it is sufficient for the face region extraction unit 54 to specify the positions of the faces respectively corresponding to the persons (the persons “A”, “B”, “C”) initially detected according to a template matching technology, and then to extract the face regions of the same persons (the same persons “A”, “B”, “C”) respectively corresponding to the respective specified positions.

Then, the facial expression determination unit 55 calculates an evaluation value for the face region of each of the persons (each of the persons “A”, “B”, “C”), and the facial expression decision unit 56 respectively saves the face regions having equal to more than a predetermined value (at least a predetermined value) in the storage unit 18.

Concerning the subsequent panoramic image-capture processing, it is sufficient to do the same processing as the above-mentioned embodiment on the face regions of each person.

In addition, although said that the template matching technique is used for the way of specifying the positions of the faces of a plurality of persons (persons “A”, “B”, “C”), the way of specifying the positions of the faces of a plurality of persons (persons “A”, “B”, “C”) is not limited thereto.

For example, by the face region of each person being saved in the storage unit 18 in advance, it may be configured so as that the face detection unit 53 detects the face of each of the persons from each of the images in panoramic image-capture processing, based on the face information of each of the persons stored in the storage unit 18.

It should be noted that the present invention is not to be limited to the aforementioned embodiments, and that modifications, improvements, etc. within a scope that can achieve the object of the present invention are included in the present invention.

For example, in the aforementioned embodiment, it is configured so that image combination processing is performed every time acquiring one image data set (Step S35 is performed when determined as YES in Step S31 of FIG. 7); however, it is not limited thereto, and it may be configured to perform image combination processing after having acquired all of the image data for panoramic combination, or it may be configured to perform image combination processing every time acquiring any plurality of image data sets of at least two.

In addition, although panoramic combination is done after overwriting of the face region in the aforementioned embodiment, the order of image combination processing is not limited thereto. In other words, overwriting of the corresponding face region may be performed after having done panoramic combination.

In addition, although it is configured to determine the facial expression of the face of a person using the evaluation value, and perform panoramic combination with a face suitable as a captured image, the target to be determined using the evaluation value is not limited to the facial expression. For example, a case is also assumed in which a shadow is cast on the person during photography of the panoramic image, and it may be configured to determine the brightness of the person or the like using an evaluation value.

In addition, although the face of a person is used as an example of the subject image included in the image data of the combination target in the aforementioned embodiment, it is not limited thereto. For example, the face of an animal may be defined as the subject image included in the image data of the combination target. In this case, whether or not the animal is closing its eyes may be adopted as the determining target using the evaluation value.

In addition, although the image processing device to which the present invention is applied has been explained with the digital camera 1 as an example in the aforementioned embodiment, it is not particularly limited thereto. The present invention can be applied to general-purpose electronic equipment having a function enabling the generation of a panoramic image, for example, and is widely applicable to portable personal computers, portable navigation devices, portable game devices, etc.

The aforementioned sequence of processing can be made to be executed by hardware, or can be made to be executed by software.

In the case of having the sequence of processing executed by way of software, a program constituting this software is installed from the Internet or a recording medium into the image processing device or a computer or the like controlling this image processing device. Herein, the computer may be a computer incorporating special-purpose hardware. Alternatively, the computer may be a computer capable of executing various functions by installing various programs, for example, a general-purpose personal computer.

The recording medium containing such a program is configured not only by the removable media 31 that is distributed separately from the main body of the equipment in order to provide the program to the user, but also is configured by a recording medium provided to the user in a state incorporated in the main body of the equipment in advance, or the like. The removable media 31 is configured by a magnetic disk (including a floppy disk), optical disk, magneto-optical disk, and the like, for example. In addition, the recording medium provided to the user in a state incorporated in the main body of the equipment in advance is configured by the ROM 12 in which the program is recorded, a hard disk included in the storage unit 18, or the like.

It should be noted that the steps describing the program recorded in the recording medium naturally include processing performed chronologically in the described order, but is not necessarily processed chronologically, and also includes processing executed in parallel or separately.

Although several embodiments of the present invention have been explained in the foregoing, these embodiments are merely exemplifications, and are not to limit the technical scope of the present invention. The present invention can adopt various other embodiments, and further, various modifications such as omissions and substitutions can be made thereto within a scope that does not deviate from the gist of the present invention. These embodiments and modifications thereof are included in the scope and gist of the invention described in the present disclosure, and are included in the invention described in the accompanying claims and the scope of equivalents thereof.

What is claimed is:

1. An image processing device, comprising:
an image acquisition unit that acquires images consecutively captured, while an image capture range is moved in a predetermined direction;
a detection unit that detects same subject images from the images acquired by the image acquisition unit;
a calculation unit that calculates evaluation values of the same subject images detected by the detection unit;
a decision unit that decides, as a combination target, a specific subject image from the same subject images, based on the evaluation values calculated by the calculation unit; and
a generation unit that generates a wide-range image by combining the specific subject image decided as the combination target by the decision unit with the images acquired by the acquisition unit.

2. The image processing device according to claim 1, further comprising:
a subject extraction unit that extracts a subject region from the same subject images; and
a subject alteration unit that alters the subject region extracted by the subject extraction unit, to the specific subject image,
wherein the generation unit generates the wide-range image by combining the specific subject image with the acquired images.

3. The image processing device according to claim 1,
wherein the acquisition unit acquires images which include a plurality of the same subject images,
wherein the detection unit detects the plurality of the same subject images from the acquired images,
wherein the calculation unit calculates evaluation values of the plurality of the same subject images detected by the detection unit,
wherein the decision unit decides specific subject images as combination targets from the plurality of the same subject images, based on the evaluation values of the plurality of the same subject images calculated by the calculation unit; and
the generation unit generates a wide-range image by combining the specific subject images decided as the combination targets with the images acquired by the acquisition unit.

4. The image processing device according to claim 1, wherein the subject image is an image centered around a face region.

5. The image processing device according to claim 1, further comprising an imaging unit,
wherein the image acquisition unit acquires images captured by the imaging unit.

6. A method for processing images by an image processing device, the method comprising the steps of:
acquiring images consecutively captured while an image capture range is moved in a predetermined direction;
detecting same subject images from the images acquired in the step of acquiring;
calculating an evaluation value of each of the subject images detected in the step of detecting;
deciding, as a combination target, a specific subject image from a plurality of the subject images, based on the evaluation values respectively calculated in the step of calculating; and
generating a wide-range image by combining the subject image decided in the step of deciding with the acquired images.

7. A computer readable recording medium encoded with a program for enabling a computer to function as:
an image acquisition unit that acquires images consecutively captured by an imaging unit moving in a predetermined direction;
a detection unit that detects same subject images from the images acquired by the image acquisition unit;
a calculation unit that calculates an evaluation value of each subject images detected by the detection unit;
a decision unit that decides, as a combination target, a specific subject image from a plurality of the subject images, based on the evaluation values respectively calculated by way of the calculation unit; and
a generation unit that generates a wide-range image by combining the subject image decided by the decision unit with the acquired images.
